(19) United States
(12) Patent Application Publication
(10) Pub. No.: US 2009/0083990 A1
(43) Pub. Date: Apr. 2, 2009

(54) Steam home appliance and control method thereof

(76) Inventors: Sang Hun Bae, Changwon-si (KR); Chang Woo Son, Changwon-si (KR); Ju Han Yoon, Changwon-si (KR)

Correspondence Address: MCKENNA LONG & ALDRIDGE LLP, 1900 K STREET, NW, WASHINGTON, DC, 20006, US

(21) Appl. No.: 12/285,224

(22) Filed: Sep. 30, 2008

(30) Foreign Application Priority Data
Oct. 1, 2007 (KR) 10-2007-0098688

(51) Int. Cl. F26B 3/02

(52) U.S. Cl. 34/486

(57) ABSTRACT

A steam home appliance and a control method thereof are disclosed. The method for controlling a steam home appliance includes sensing a temperature of water for generating steam, determining a heating time of heating water to generate steam according to the sensed temperature, and correcting a predetermined operating time of the steam home appliance according to the determined heating time. Accordingly, the steam home appliance is convenient in use by setting a correct operating time during operation using steam.

This application claims the benefit of Korean Patent Application No. 10-2007-0098688 filed on Oct. 1, 2007, which is hereby incorporated by reference as if fully set forth herein.

### BACKGROUND OF THE INVENTION

1. Field of the Invention

The present invention relates to a home appliance using steam, and more particularly, to a steam home appliance which is convenient in use by setting a correct operating time during operation using steam.

2. Discussion of the Related Art

In general, home appliances refer to electric appliances that are used at home. Such home appliances include clothes treating machines to treat clothes, dishwashers to treat dishes, and so on.

Clothes treating machines typically include washing machines to wash laundry, and laundry dryers to dry laundry.

Laundry dryers are electric appliances that dry washed laundry, mainly washed clothes, by using high temperature air. In general, a laundry dryer comprises a laundry storing part to store laundry. The laundry dryer is constituted to supply dry air to the laundry storing part and to exhaust damp air from the laundry storing part. Through such processes, the washed laundry is dried.

Laundry dryers may be categorized, based on a method of heating air, i.e., heating means, into electric type laundry dryers and gas type laundry dryers. In an electric type laundry dryer, air is heated by using electric resistance heat. In a gas type laundry dryer, air is heated by using heat generated from gas combustion.

On the other hand, laundry dryers may be categorized into condensation type laundry dryers and exhaustion type laundry dryers. In a condensation type laundry dryer, air is heat-exchanged with laundry in the drum and the damp air is circulated without being discharged outside the laundry dryer, to be heat-exchanged with external air at an auxiliary condenser. At this time, condensed water is generated and discharged outside. In an exhaustion type laundry dryer, air is heat-exchanged with laundry in the drum and the damp air is directly discharged outside the laundry dryer.

Further, laundry dryers may be categorized, based on a method of loading laundry, into top loading type laundry dryers and front loading type laundry dryers. In a top loading type laundry dryer, laundry is loaded into the drum through a top of the laundry dryer. In a front loading type laundry dryer, laundry is loaded into the drum through a front of the laundry dryer.

Further, laundry dryers may be categorized, based on a type of laundry storing part, into cabinet type laundry dryers and drum type laundry dryers.

In a cabinet type laundry dryer, laundry may be hung on clothes racks or laid on shelves in a laundry storing part.

A drum type laundry dryer comprises a drum to store laundry, a driving source to drive the drum, heating means to heat air drawn into the drum, and a fan to suck or discharge air from the drum.

However, the above conventional laundry dryers have the following problems.

Commonly, the washed and dehydrated laundry is loaded and dried in the laundry dryer. In view of a principle of water washing, the washed laundry has wrinkles, and the wrinkles are not removed during a drying process in the laundry dryer. As a result, the conventional laundry dryer has a shortcoming such that a user should iron out the dried laundry to remove the wrinkles.

Moreover, in a case where clothes besides the washed laundry are kept and used, the clothes may have wrinkles, crumples and fold marks (hereinafter, commonly referred to as “wrinkles”). Accordingly, there have been demands for development of devices capable of also easily removing the wrinkles generated by the common usage and storage of the clothes.

Recently, a drum type washing machine using steam is being spotlighted. A drum type washing machine using steam has effects of higher washing efficiency and higher energy efficiency, when compared to a boiling washing machine.

However, a drum type washing machine, which performs courses using steam, has a problem such that a total operating time is not constant due to deviation of a steam generating time. That is, though a preset operating time has elapsed, the washing machine is further operated. On the other hand, the operation of the washing machine is terminated before a preset operating time elapses. Thus, reliability of the drum type washing machine is deteriorated.

In this regard, when the steam drum washing machine performs courses using steam, it is necessary to set a correct operating time. Such a demand is identically applied to a laundry dryer using steam, a steam dishwasher for washing or sterilizing dishes using steam, or the like.

### SUMMARY OF THE INVENTION

Accordingly, the present invention is directed to a steam home appliance and a control method thereof that substantially obviate one or more problems due to limitations and disadvantages of the related art.

An object of the present invention is to provide a steam home appliance which enables a user to more easily use steam and has high reliability.

Another object of the present invention is to provide a steam home appliance, such as a clothes treating machine or a dishwasher, which enhances user's convenience by displaying a correct operating time to a user.

A further object of the present invention is to provide a steam home appliance which prevents a user from misunderstanding that the steam home appliance is erroneously operated due to deviation of an operating time, by providing a user with information about a correct operating time.

Yet another object of the present invention is to provide a laundry dryer which can remove wrinkles, static and odor, thereby increasing a degree of practical use of the laundry dryer.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for controlling a steam home appliance comprises: sensing a temperature of water for generating steam; determining a heating time of heating water to generate steam according to the sensed temperature; and correcting a predetermined operating time of the steam home appliance according to the determined heating time.

The step of determining the heating time may include determining the heating time through an operation of an experimental equation according to the sensed temperature, or may include deriving the heating time from a table, in which relation between the sensed temperature and the heating time corresponding thereto is preset.

The heating time may be a time from starting heating water to starting supplying steam to an object storing part. The heating time may be a time from starting heating water to increasing a temperature in a steam generating device to a predetermined temperature. Preferably, the predetermined temperature is 100° C. or more. This is because the evaporation point of water in a normal state is 100° C. or more. More preferably, in order to secure safety and to supply steam (not heated water) from the steam generating device, the predetermined temperature is set to be 102° C. or more.

Preferably, the control method further comprises displaying the predetermined operating time when operation is started. By displaying the operating time to a user, convenience in use is improved. Preferably, the step of displaying includes displaying a remaining operating time as time passes by.

Preferably, the step of displaying includes displaying the remaining operating time depending on the corrected operating time. That is, by displaying the remaining operating time, which correctly or substantially coincides with the practical remaining operating time, to a user, convenience in use is improved.

The predetermined operating time may be predetermined according to an operating course or the amount of object at the beginning of operation. The amount of object at the beginning of operation may be sensed by sensing means in the home appliance, or may be inputted by a user.

The step of sensing may include sensing a temperature of water to be supplied to the steam generating device, or may include sensing a temperature of water which is being supplied to the steam generating device. The step of sensing may include sensing a temperature of water supplied to the steam generating device, or may include sensing a temperature of water after the water supply is completed. That is, a point of time of sensing a temperature of water for steam generation may vary as needed. However, in order to determine the most correct steam generating time, it is preferable to sense a temperature of water just before being heated.

The water temperature may be indirectly sensed by sensing an ambient temperature in the steam generating device. This is related to a mounting position of a temperature sensor in the steam generating device. In other words, this is related to a portion, a temperature of which is sensed by the temperature sensor, on the assumption that water is stored in a lower portion of the steam generating device, and steam and air exist in an upper portion of the steam generating device. A temperature sensor for sensing the water temperature and a temperature sensor for sensing an ambient temperature in the steam generating device may be separately provided. However, from a point of view of costs and system constitution, there may be necessity to use a single temperature sensor.

Preferably, the steam home appliance includes an operating course having a steam generating process of heating water to generate steam, and a steam supplying process of supplying the generated steam to the object storing part.

In a case of washing machine, the object refers to laundry, and the object storing part refers to a tub or a drum. In a case of laundry dryer, the object refers to an object to be dried, and the object storing part refers to a drum. In a case of dishwasher, the object refers to dishes, and the object storing part refers to a tub. Because this is well known in this art, detailed explanation thereof will be omitted.

More particularly, the step of determining may include determining a time necessary for the steam generating process, and the step of correcting may include correcting the predetermined operating time according to the determined time necessary for the steam generating process.

The operating course may further include a cooling process of lowering a temperature in the object storing part after the steam supplying process, and may further include a drying process of supplying hot air to the object storing part before the steam supplying process.

In accordance with another purpose of the invention, a method for controlling a steam home appliance comprises: sensing a temperature of water for generating steam; determining a heating time of heating water to generate steam according to the sensed temperature; and correcting a time necessary for a sub-process to keep a predetermined operating time of the steam home appliance according to the determined heating time.

Preferably, the steam home appliance includes an operating course having a steam generating process of heating water to generate steam, and a steam supplying process of supplying the generated steam to an object storing part.

Preferably, the sub-process, the time necessary for which is corrected, includes other processes except for the steam generating process.

Preferably, the operating course further includes the sub-process including at least one of a drying process of supplying hot air to the object storing part before the steam supplying process and a cooling process of lowering a temperature in the object storing part after the steam supplying process. The sub-process may be a washing process of washing laundry by using water and detergent, or a washing process of washing dishes by using water and detergent.

The sub-process, the time necessary for which is corrected, may be the drying process, the laundry washing process, the dish washing process, or the cooling process. A time necessary for any one sub-process may be corrected, and a time necessary for a plurality of sub-processes may be corrected.

The control method may further comprise displaying the predetermined operating time when operation is started. The step of displaying may include displaying a remaining operating time as time passes by. The step of displaying may include displaying the remaining operating time depending on the corrected time necessary for the sub-process.

The predetermined operating time may be predetermined according to an operating course or the amount of object at the beginning of operation. The amount of object may be automatically sensed by sensing means in the home appliance, or a user may select the amount of object.

In accordance with a further purpose of the invention, a steam home appliance comprises: a steam generating device to generate steam; an object storing part to store an object therein, the object storing part receiving steam generated from the steam generating device; a temperature sensor to sense a temperature of water for generating steam; and a controller to control the steam home appliance to be operated during an operating time which is corrected depending on the temperature sensed by the temperature sensor.

The controller may determine a heating time of heating water for steam generation depending on the temperature sensed by the temperature sensor. The heating time may be derived from an experimental equation, or may be a time which is preset according to the water temperature. In the latter case, the controller controls the steam home appliance to be operated during the operating time which is corrected based on the preset time depending on the sensed temperature.

Preferably, the steam home appliance further comprises a display part to display the preset operating time at the beginning of operation and to display a remaining operating time as time passes by. The display part displays the remaining operating time based on the corrected operating time.

In accordance with yet another purpose of the invention, a steam home appliance comprises: a steam generating device to generate steam; an object storing part to store an object therein, the object storing part receiving steam generated from the steam generating device; a temperature sensor to sense a temperature of water for generating steam; and a controller to control the steam home appliance to be operated during a preset operating time by correcting a time necessary for a sub-process depending on the temperature sensed by the temperature sensor.

The controller determines a time necessary for a steam generating process of heating water for steam generation depending on the temperature sensed by the temperature sensor. The controller corrects a time necessary for the sub-process according to the determined time necessary for the steam generating process, thereby keeping the preset operating time.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is an exploded perspective view illustrating a steam home appliance in accordance with an exemplary embodiment of the present invention;

FIG. 2 is a longitudinal-sectional view of the steam home appliance shown in FIG. 1;

FIG. 3 is a sectional view illustrating a steam generating device shown in FIG. 1;

FIG. 4 is a schematic view illustrating a steam generating device of a steam home appliance in accordance with another exemplary embodiment of the present invention;

FIG. 5 is a schematic view of a control panel of the steam home appliance in accordance with the present invention;

FIG. 6 is a graph showing relationship between an initial water temperature and a steam start time;

FIG. 7 is a flow diagram showing a control method in accordance with an exemplary embodiment of the present invention; and

FIG. 8 is a flow diagram showing a control method in accordance with another exemplary embodiment of the present invention.

### DETAILED DESCRIPTION OF THE INVENTION

Reference will now be made in detail to the preferred embodiments of the present invention associated with a home appliance using steam, examples of which are illustrated in the accompanying drawings. More particularly, a steam home appliance capable of displaying a more correct operating time to a user will be described. Wherever possible, the same reference numbers will be used throughout the drawings to refer to the same or like parts.

A steam home appliance may include a washing machine, a laundry dryer, a dishwasher and so on. Hereinafter, constitution of a laundry dryer will be explained in detail. For convenience of explanation of a steam home appliance according to the present invention, a front loading type, gas type and exhaustion type laundry dryer will be exemplified. However, the present invention is not limited to the above example, and can also be applied to other types of laundry dryers, such as a top loading type, electric type and condensation type laundry dryer. Of course, the present invention can also be applied to other home appliances, such as a washing machine.

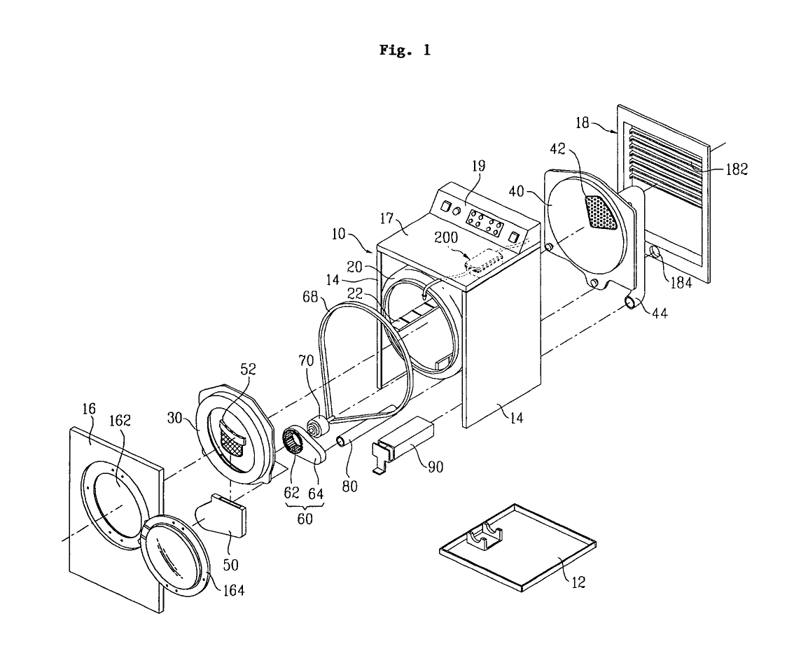

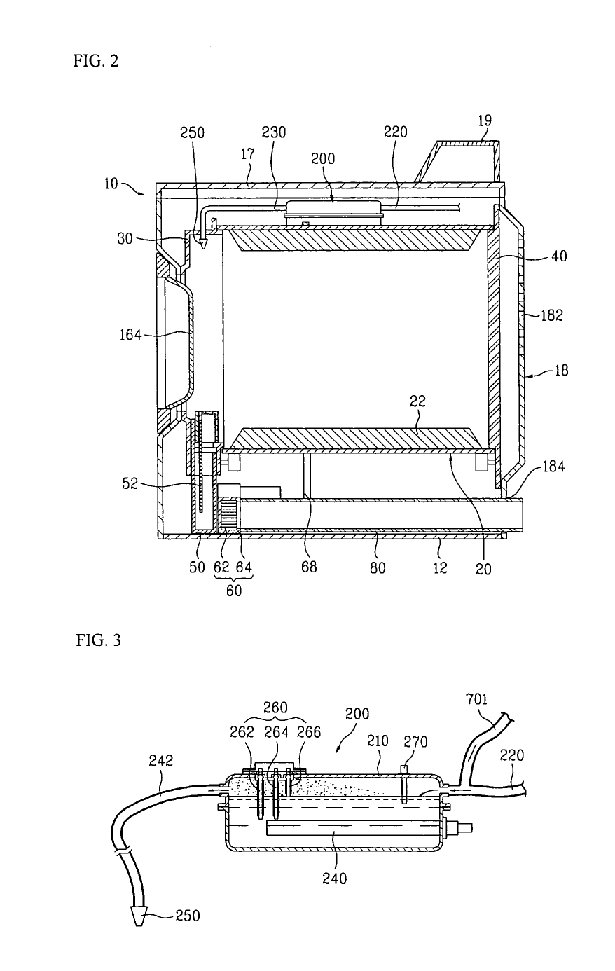

FIG. 1 is an exploded perspective view illustrating a laundry dryer in accordance with an exemplary embodiment of the present invention, and FIG. 2 is a longitudinal-sectional view of FIG. 1.

A laundry dryer according to an exemplary embodiment of the present invention will now be described with reference to FIGS. 1 and 2.

A cabinet 10 defines an exterior appearance of the laundry dryer according to the present invention, and houses components described below. Inside the cabinet 10 are mounted a rotatable drum 20, and a motor 70 and a belt 68 to drive the drum 20. A heater 90 (hereinafter, referred to as “hot air heater”) is mounted in a predetermined portion of the cabinet 10 to create air of high temperature (hereinafter, referred to as “hot air”) by heating the air. A dry air supply duct 44 is mounted in a predetermined portion of the cabinet 10 to supply the hot air generated from the hot air heater 90 to the drum 20. Also, there are provided an exhaustion duct 80 and a fan 60 in the cabinet 10. The damp air heat-exchanged with the laundry in the drum 20 is discharged outside the drum 20 through the exhaustion duct 80, and the damp air is sucked by the fan 60. A steam generating device 200 is mounted in a predetermined portion of the cabinet 10 to generate steam of high temperature.

Cool air as well as hot air may be supplied to the drum. If the hot air heater 90 is in an OFF state and only the fan 60 is driven, cool air is supplied to the drum. In any case of supplying hot air or cool air, dry air is preferably supplied to remove moisture from the laundry. Accordingly, the air supplied to the drum will be referred to as dry air for convenience of explanation hereinafter.

The drum 20 is a laundry storing part to store the laundry thereinside. The drum 20, the hot air heater 90, the fan 60 and the ducts 44 and 80 may compose a drying device.

For convenience of explanation, this embodiment shows and describes an indirect drive type such that the drum 20 is rotated by the motor 70 and the belt 68, however the present invention is not limited to the indirect drive type. In other words, the present invention can also be applied to a direct drive type such that the drum 20 is directly rotated by directly connecting the motor to a rear surface of the drum 20.

The aforesaid components will now be explained in detail.

The cabinet 10 defining the exterior appearance of the laundry dryer includes a base 12 forming a bottom surface, a pair of side covers 14 vertically mounted to the base 12, a front cover 16 mounted to front surfaces of the side covers 14, a rear cover 18 mounted to rear surfaces of the side covers 14, and a top cover 17 mounted to top surfaces of the side covers 14. A control panel 19 having various operational switches is generally positioned on the top cover 17 or the front cover 16, and a door 164 is coupled to the front cover 16. An air inlet 182 and an air outlet 184 are provided at the rear cover 18. External air is drawn through the air inlet 182, and the air in the drum 20 is discharged outside through the air outlet 184 that is a final path to the outside.

An inner space of the drum 20 serves as a drying chamber for drying the laundry. It is preferred that a lifter 22 is installed in the drum 20 to lift and drop the laundry, so that the laundry is turned over to enhance drying efficiency.

A front supporter 30 and a rear supporter 40 are provided between the drum 20 and the cabinet 10. More particularly, the front supporter 30 is provided between the drum 20 and the front cover 16, and the rear supporter 40 is provided between the drum 20 and the rear cover 18. The drum 20 is rotatably mounted between the front supporter 30 and the rear supporter 40, and sealing members (not shown) for preventing water leakage are provided between the front supporter 30 and the drum 20 and between the drum 20 and the rear supporter 40. The front supporter 30 and the rear supporter 40 shield a front surface and a rear surface of the drum 20, respectively, to form the drying chamber, and support a front end and a rear end of the drum 20.

An opening is formed at the front supporter 30 to communicate the drum 20 with the outside of the laundry dryer. The opening is selectively opened and closed by the door 164. A lint duct 50, through which the air in the drum 20 flows outside, is connected to the front supporter 30, and a lint filter 52 is installed in the lint duct 50.

A portion of the fan 60 is connected to the lint duct 50, and an opposite portion of the fan 60 is connected to the exhaustion duct 80. The exhaustion duct 80 is in communication with the air outlet 184 provided at the rear cover 18.

Accordingly, if the fan 60 operates, the air in the drum 20 flows through the lint duct 50, the exhaustion duct 80 and the air outlet 184 in order, and is discharged outside. At this time, foreign substances including lint are filtered out by the lint filter 52. The fan 60 typically consists of a blower 62 and a blower housing 64. The blower 62 is commonly connected to the motor 70 for driving the drum 20.

An opening portion 42 including a plurality of through-holes is formed at the rear supporter 40, and the dry air supply duct 44 is connected to the opening portion 42. The dry air supply duct 44 is in communication with the drum 20, and serves as a path for supplying dry air to the drum 20. For this, the hot air heater 90 is mounted in a predetermined portion of the dry air supply duct 44.

The steam generating device 200 is mounted in a predetermined portion of the cabinet 10 to generate steam and supply the steam to the drum 20.

FIG. 3 is a sectional view illustrating the steam generating device shown in FIG. 1. The steam generating device 200 will now be explained in detail with reference to FIG. 3.

The steam generating device 200 includes a water tank 210 to store water therein, a heater 240 mounted in the water tank 210, a water level sensor 260 to measure a water level in the steam generating device 200, and a temperature sensor 270 to measure a temperature of the steam generating device 200. The water level sensor 260 includes a common electrode 262, a low water level electrode 264 and a high water level electrode 266. A high water level is sensed based on whether an electric current is applied between the common electrode 262 and the high water level electrode 266, and a low water level is sensed based on whether an electric current is applied between the common electrode 262 and the low water level electrode 264.

The temperature sensor 270 senses a temperature of water stored in the steam generating device 200. When water is heated and converted into steam, the temperature sensor 270 senses a temperature of the steam or a temperature in the steam generating device 200.

However, the temperature sensor 270 is not necessarily provided in the steam generating device 200, under the premise of that a temperature of water for generating steam should be sensed. This is because it will be good to sense a temperature of water before flowing into the steam generating device 200 or a temperature of water that is flowing into the steam generating device 200. Therefore, it may be possible to mount the temperature sensor 270 to either the path for flowing water to the steam generating device 200 or the inside of the steam generating device 200. Also, the temperature sensor 270 may indirectly sense a temperature of water for generating steam through the case 210 of the steam generating device 200 or an ambient temperature in the steam generating device 200.

A water supply hose 220 is connected to a portion of the steam generating device 200 to supply water, and a steam supply line 242 is connected to an opposite portion of the steam generating device 200 to discharge steam. It is preferred that a nozzle 250 having a predetermined shape is provided at a front end of the steam supply line 242. An end of the water supply hose 220 is typically connected to a water supply source for supplying water to the steam generating device 200. The front end of the steam supply line 242 or the nozzle 250, that is, a steam outlet, is positioned at a predetermined portion of the drum 20 to spray steam into the drum 20. Here, the water supply source may be configured as an external water tap.

Further, it is preferable to supply condensed water in a condensed water tank (not shown) as well as water from the water supply source to the steam generating device 200. To achieve this, it is preferred that the steam generating device 200 is connected with a condensed water supply line 701, through which condensed water from the condensed water tank flows. As shown in FIG. 3, the condensed water supply line 701 may be connected to the water supply hose 220, or may be directly connected to the steam generating device 200 through a condensed water inlet (not shown) separately formed at the steam generating device 200.

The condensed water tank is an essential component of a condensation type laundry dryer. As needed, the condensed water tank may also be provided in an exhaustion type laundry dryer. Because the condensed water tank is well known in this art, detailed explanation of the condensed water tank will be omitted.

Although this embodiment shows and describes the steam generating device 200 in which the heater 240 heats the water in the water tank 210 to generate steam (hereinafter, referred to as “tank heating type steam generating device” for convenience of explanation), the present invention is not limited to the tank heating type steam generating device. In other words, any device capable of generating steam may be used as the steam generating device in the present invention. For example, a steam generating device in which a heater is directly installed around or inside a case to heat water flowing through the case, without storing water in a predetermined space, (hereinafter, referred to as “pipe heating type steam generating device” for convenience of explanation), may be applicable to the present invention. In such a pipe heating type steam generating device, the water flowing in the steam generating device is heated and converted into steam.

It is more preferable to use the tank heating type steam generating device as the steam generating device in the present invention, rather than to use the pipe heating type steam generating device. This is because when the stored water is heated, deviation of a time necessary to generate steam is relatively large according to a water temperature. The tank heating type steam generating device has an advantage of more stably and evenly supplying steam. Further, the tank heating type steam generating device can generate steam of good quality regardless of a water temperature, and can save energy for steam generation.

Because the pipe heating type steam generating device generates steam by heating the flowing water, when a temperature of water is low, it has a problem such that the heated water (not steam) is discharged. In order that only steam is always discharged, a heating capacity should be very large. However, in such a case, overheated steam may be generated, which causes a waste of energy for steam generation.

In the pipe heating type steam generating device, if a length of a fluid passage, in which heat exchange occurs, is increased and an outlet is selectively opened or closed so as to discharge only steam, deviation of a time necessary to generate steam is generated according to a water temperature. Thus, also when the pipe heating type steam generating device is used, because of the time deviation, the operating time should be corrected or kept constant.

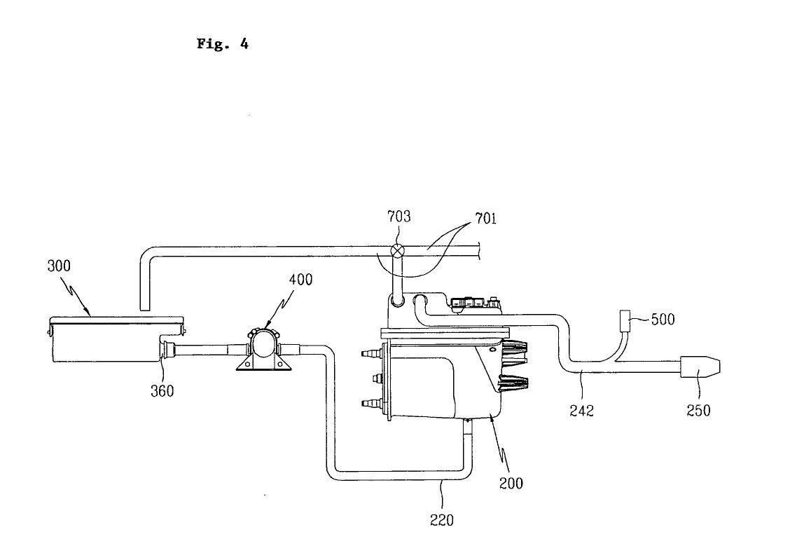

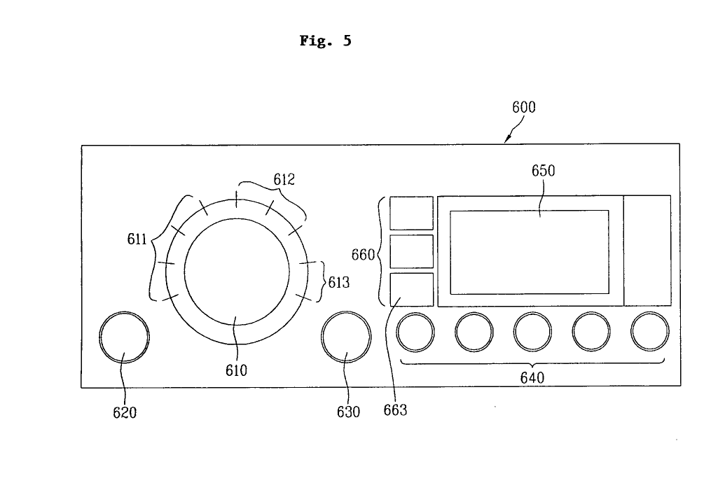

FIG. 4 is a schematic view illustrating a steam generating device of a laundry dryer in accordance with another exemplary embodiment of the present invention. A laundry dryer in accordance with another embodiment of the present invention will now be described with reference to FIG. 4.

In this embodiment, a water supply source 300 for supplying water to the steam generating device 200 is mounted in the laundry dryer. The water supply source 300 is formed in a tank shape, which can store a predetermined amount of water. Preferably, the water supply source 300 is detachably mounted in the laundry dryer. This is for enabling a user to easily fill the water supply source 300 with water or empty the water supply source 300. The water supply source 300 may be configured as an external water tap as described in the above-described embodiment. However, in such a case, the installation becomes complicated. This is because the laundry dryer does not commonly use water, if the water tap is used as the water supply source, various devices annexed thereto should be additionally installed. Accordingly, this embodiment using the detachable water supply source 300 is very convenient in use. In other words, the water supply source 300 is detached from the laundry dryer to be filled with water, and then the water supply source 300 filled with water is connected to a water supply passage of the steam generating device 200, i.e., the water supply hose 220. Further, if condensed water generated during the operation of the laundry dryer is supplied to the water supply source 300, it can reduce a user's labor of filling the water supply source 300 with water.

Using the condensed water can minimize a problem of scales, which might occur when using tap water. Although condensed water is excessively supplied to the water supply source 300, a user can easily carry the detachable water supply source 300 and can pour condensed water out of the water supply source 300. This is very useful when the laundry dryer is installed in a space which is not equipped with a drainage. The sensor for sensing a temperature of water for steam generation may be provided in the water supply source 300.

It is preferred that a pump 400 is provided between the water supply source 300 and the steam generating device 200. More preferably, the pump 400 can rotate in a forward direction and a reverse direction, so as to supply water to the steam generating device 200 or collect residual water in the steam generating device 200 as needed. The reason for collecting residual water in the steam generating device 200 is to prevent or minimize accumulation of scales in the steam generating device 200. Thus, if condensed water is used to generate steam, the collection of residual water may be unnecessary. In such a case, a pump capable of rotating only in a forward direction may be used.

The pump may be substituted by an on/off valve, which can be achieved by using a difference in water column heights between the water supply source 300 and the steam generating device 200. In other words, it is possible to supply water from the water supply source 300 to the steam generating device 200 by using gravity. In such a case, the on/off valve is turned ON, so that water can be automatically supplied from the water supply source to the steam generating device.

In such a case, the water supply source 300 is provided above the cabinet 10, and the steam generating device 200 is provided under the cabinet 10. Of course, if necessary, the pump 400 may be mounted in such a constitution so at to supply water for steam generation from the water supply source 300 to the steam generating device 200.

While the above-described embodiment is configured such that the water supply and the steam exhaustion are achieved through the upper portion of the steam generating device 200, this embodiment is configured such that water is supplied through the lower portion of the steam generating device 200 and steam is exhausted through the upper portion of the steam generating device 200. Such a configuration of this embodiment is effective to collect residual water in the steam generating device 200.

The steam generating device 200 may be connected with the condensed water supply line 701, and the water supply source 300 also may be connected with the condensed water supply line 701. Condensed water for steam generation may be supplied directly to the steam generating device 200, or to the water supply source 300 from a condensed water tank (not shown) through the condensed water supply line 701. Of course, condensed water may be supplied directly to both the steam generating device 200 and the water supply source 300. In such a case, a valve 703 may be provided in the condensed water supply line 701, so as to determine an order of supplying condensed water. The valve 703 makes it possible to first supply condensed water to the steam generating device 200 and then to supply condensed water to the water supply source 300. Also, it is possible to first supply condensed water to the water supply source 300 and then to supply condensed water to the steam generating device 200. The temperature sensor for sensing a temperature of water for steam generation may be provided in the condensed water tank.

Also, it is preferred that a safety valve 500 is provided at a steam passage for discharging steam from the steam generating device 200, i.e., the steam supply line 242. This is for preventing an accident by restraining an increase in steam pressure when the steam passage, specifically the nozzle 250 is choked.

In the above description, the constitution of the laundry dryer has been explained in detail as an example of the home appliance according to the present invention. However, as described above, the home appliance according to the present invention includes a washing machine and a dishwasher. In such a home appliance, specifically the home appliance using steam, steam is supplied to increase an ambient temperature in an object storing part and a temperature of the object. In addition, steam serves to supply moisture to the object. The purposes of supplying steam may vary depending on the type of the home appliance.

In a case of laundry dryer, steam is used to effectively remove wrinkles and static by evenly supplying moisture to the object to be dried. In a case of washing machine, steam is used for rapid cloth wetting, sterilization and promotion of activation of detergent, thereby enhancing washing ability. In a case of dishwasher, steam is used to easily remove contaminants, sterilize dishes and promote activation of detergent, thereby enhancing washing ability.

Because general constitution of the washing machine and the dishwasher is well known in this art and is not closely related to the technological idea of the present invention, detailed explanation thereof will be omitted. However, the above-described constitution related to the steam generating device is applicable to the washing machine or the dishwasher.

Hereinafter, a control panel 600 of the home appliance according to the present invention will be explained with reference to FIG. 5.

The home appliance includes the control panel 600 for interfacing with a user. It is preferred that the control panel 600 is positioned at a front upper portion of the home appliance, in order to enable a user to easily get access to the control panel 600.

A controller (not shown) is mounted inside the control panel 600 to control the operation of the home appliance. That is, if a user inputs a command for operating the home appliance by manipulating the control panel 600, the controller controls the operation of the home appliance according to the preset program. Here, the controller controls the operation of the home appliance based on options and information inputted by a user. The controller is positioned separately from the control panel, and transmits and receives signals to/from the control panel by wireless or wire communication.

As shown in FIG. 5, the control panel 600 includes a course selection part 610 constituted to enable a user to select courses, and a steam option selection part 660 constituted to enable a user to select whether steam is used or not. The courses may include a course in which steam is automatically used. In such a case, the steam option selection part 660 may be constituted to enable a user to select a steam supply time and/or a steam supply amount.

Here, the course refers to a series of operational processes from the start to the automatic end in the home appliance. For instance, in a case of washing machine, a “standard course” of the various laundry washing courses refers to a course by which the washing machine operates in order of a washing process, a rinsing process and a dehydrating process and terminates the operation. Except for a specific case, once a user selects one of the courses, the washing machine is operated as programmed in advance. Concrete operational conditions are differently set according to the respective courses. For example, the courses are programmed with respectively different total course operating time, the number of revolutions of the drum, combinations of sub-processes and so on.

As shown in the drawing, the course selection part 610 may be formed in a dial knob shape, so that a user can select a desired course by rotating the dial knob. The steam option selection part 660 may include a plurality of buttons, so that a user can select an option related to steam by pushing the buttons.

The courses may be diversely provided according to the kind of home appliance, material of an object (e.g., laundry), the degree of staining, a specific purpose, etc. For convenience of explanation, the present invention will now be explained with reference to a drum type washing machine.

In a drum type washing machine, the courses may include a steam exclusion course 613, a steam selection course 612 and a steam inclusion course 611. Theses courses are related to a steam process, in which steam is supplied to the drum.

The steam exclusion course 613 refers to a course in which the steam process is automatically excluded. For example, the steam process is excluded in order to prevent damage to the laundry, especially delicate clothes made of silk or wool, due to steam. Also, when intending to wash the bulky laundry, such as bedclothes, the steam exclusion course 613 is selected.

The steam inclusion course 611 refers to a course in which the steam process is automatically included. That is, the steam process is automatically performed during the course operation. For example, the steam inclusion course 611 may include a steam cleaning course and an allergy-care course for removing allergy-inducing substances by use of steam. In many cases, the steam inclusion course is programmed in advance so that the course can be performed under the optimum conditions.

The steam selection course 612 refers to a course in which the steam process is selectively performed by the user's selection. For example, the aforementioned standard course does not cause laundry damage due to steam but can get an effect of enhancement of sterilization and washing ability using steam. Thus, the standard course can be defined as the steam selection course.

The steam exclusion course, the steam inclusion course and the steam selection course may respectively include at least one course. However, the drum type washing machine does not necessarily include all of the steam exclusion course, the steam inclusion course and the steam selection course.

As described above, the courses may include sub-processes. For example, at least one of the washing process, in which the laundry is washed by using water and detergent, and the rinsing process, in which the laundry is rinsed by using water, may be included. The courses may include the dehydrating process, in which the laundry is dehydrated, and may also include the drying process, in which the laundry is dried by supplying dry air to the drum. As such, a user can select a desired course through the course selection part 610.

The courses performed in the steam laundry dryer may include a simple drying course, a refresh course using steam, a static removing course using steam, a course using steam after drying, etc. Depending on the type of object to be dried, such courses may be further segmented, or other courses may be added.

In the same manner, the courses performed in the dishwasher may include a washing course of washing dishes by using only water and detergent, a washing course using steam together, etc. Depending on the kind of dishes or the contamination degree, such courses may be further segmented, or other courses may be added.

The control panel 600 further includes a display part 650. The display part 650 serves to display an operating state or an operating time of the home appliance for convenience of use.

The control panel 600 further includes a plurality of option selection buttons 640, so that a user can select an option in each course. In a case of washing machine, the options may include a washing time, a washing water amount, the number of rinsing processes, etc.

A non-described reference numeral 620 denotes a power button of the home appliance, and a non-described reference numeral 630 denotes a start/stop button.

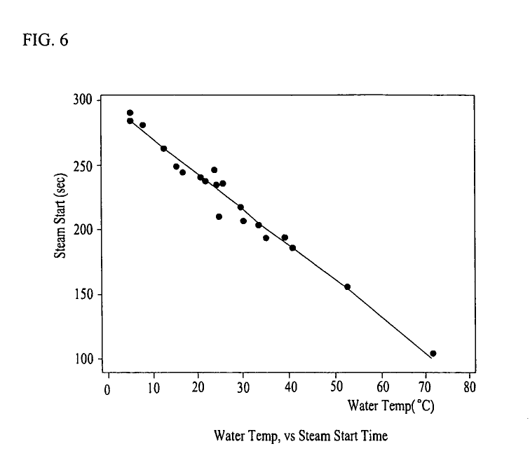

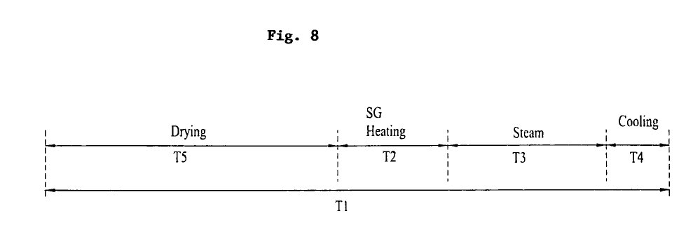

Hereinafter, a method for controlling the home appliance according to the present invention will be explained in detail with reference to FIGS. 6 to 9. A laundry dryer will be exemplified as the home appliance according to the present invention.

As shown in FIG. 6, a time necessary to generate steam by heating water varies according to an initial temperature of water. That is, a time necessary to convert water of low temperature into steam is longer than a time necessary to convert water of high temperature into steam.

Thus, depending on a temperature of water for steam generation, a time of heating water to generate steam varies. The relationship between the initial water temperature and the water heating time can be expressed by an experimental equation or a table. The above relationship may be determined in advance depending on a capacity of the heater for heating water, an inner volume of the steam generating device and the amount of water stored in the steam generating device.

Thus, if the laundry dryer includes a steam supplying process of supplying steam to the object storing part and a steam generating process of heating water to generate steam, a time necessary for the steam generating process varies according to a temperature of water for steam generation.

Here, the difference in the water temperature may be caused by change of the water temperature according to the season. Further, if the steam generating device is used again soon after the operation of the steam generating device, the water temperature is kept at a relatively high temperature owing to remaining heat. The change of the water temperature may be resulted from the above reasons.

It can be known from FIG. 6 that it takes about 240 seconds, i.e., 4 minutes to heat water of normal temperature until steam is generated. It also can be known that it takes about 2 minutes to heat water of 70° C. until steam is generated, and it takes about 7 minutes to heat water of 10° C. until steam is generated. A problem caused by deviation of time necessary for the steam generating process should be solved. A graph of FIG. 6 just shows one example of deviation of time necessary for the steam generating process. Under various conditions, the deviation of time may show other patterns different from the graph of FIG. 6.

A table may be preset so that a time necessary for the steam generating process one-to-one corresponds to the sensed water temperature, and may be pre-stored in the controller. In such a case, if the water temperature is sensed, a time necessary for the steam generating process is automatically determined. A time necessary for the steam generating process depending on the water temperature may be expressed by the linear experimental equation as shown in FIG. 6. If the water temperature is sensed, a time necessary for the steam generating process may be determined through the experimental equation.

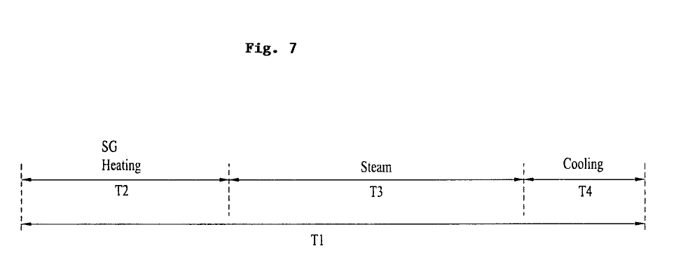

As shown in FIG. 7, the steam home appliance according to the present invention, specifically the laundry dryer, may include a refresh course of refreshing an object to be dried by supplying steam to the drum.

If a user selects the refresh course, a total operating time T1 of the refresh course can be determined automatically or based on the amount of objects to be dried, etc. The total operating time T1 is the sum of a steam generating process time T2 and a steam supplying process time T3.

Preferably, the total operating time T1 is displayed through the aforementioned display part 650. As the operation is performed, the total operating time is displayed in a countdown manner. That is, it is preferred that a remaining operating time is displayed.

If the steam supplying process time T3 is 5 minutes, the steam generating process time T2 is automatically set to 4 minutes, and as a result the total operating time T1 is set to 9 minutes. However, though the steam generating process time T2 is practically set to 4 minutes, the time T2 may vary depending on the temperature of water for steam generation. In such a case, the practical total operating time also should be changed. In order to solve this problem, a process of sensing a temperature of water for steam generation is first performed. Thereafter, depending on the sensed temperature, a time of heating water until steam is generated is determined. That is, the steam generating process time T2 is determined.

If the steam generating process time T2 is determined to 2 minutes, the preset operating time of the home appliance, i.e., the total operating time T1 is corrected from 9 minutes to 7 minutes.

Since the steam generating process is performed at the beginning of the course, the total operating time can be displayed through the display part 650 with the corrected operating time from the beginning. However, in a case where the steam generating process is not performed at the beginning of the course, it may be controlled such that the preset total operating time is first displayed, and then the corrected operating time is displayed.

Through such a control method, a user can get information about the correct operating time, which substantially coincides with the practical total operating time. Accordingly, an unnecessary waste of time can be prevented.

Because a temperature in the drum is high due to the steam generating process, the course may further include a cooling process of lowering the temperature in the drum. The cooling process prevents a user from suffering a burn after the end of the course, and also enables a user to wear the clothes soon. If a cooling process time is set to T4, the total operating time T1 is the sum of T2, T3 and T4.

The refresh course can be defined to include the steam generating process, the steam supplying process and the cooling process. Such processes can be defined as sub-processes composing a single course.

Different from described above, it may be controlled such that the preset operating time of the home appliance, i.e., the total operating time is kept without being changed.

For example, if the steam generating process time is 4 minutes, the steam supplying process time is 5 minutes and the cooling process time is 1 minute, the total operating time is preset to 10 minutes (the sum of 4 minutes, 5 minutes and 1 minute).

Accordingly, “10 minutes” is displayed at the beginning of the course, and a temperature of water for steam generation is sensed. Depending on the sensed temperature, a time of heating water until steam is generated, i.e., the steam generating process time is determined. If the steam generating process time is determined to 2 minutes, in order to keep the preset total operating time, it is controlled such that the operating time of the sub-processes except for the steam generating process is corrected. In order to compensate the time of 2 minutes, for example, the steam supplying process time may be extended by 1 minute, and the cooling process time may be extended by 1 minute. Alternatively, only a time of any one of the sub-processes may be extended. On the other hand, if the steam generating process time is determined to 6 minutes, a time of the sub-processes may be shortened.

Accordingly, it can be controlled such that the total operating time displayed at the beginning of the course substantially coincides with the practical operating time. As a result, a difference between the practical operating time and the displayed operating time is minimized, thereby maximizing user's convenience.

The refresh course includes a course for removing wrinkles, odor or static by supplying steam to the dried object.

To supply steam to the dried object is for smoothing out or removing wrinkles of the object by evenly supplying moisture of high temperature to the object. In addition, volatile odor particles can be removed owing to high temperature, and nonvolatile odor particles also can be removed by evaporation of the moisture supplied to the dried object. Accordingly, an excellent wrinkle/odor removing effect can be obtained through the steam supply.

Static may remain on the dried-out object, which causes a user to feel unpleasant when she/he takes the object out of the drum. To solve this problem, the predetermined amount of steam is supplied to the drum after the end of the drying process, so as to decrease static.

As described above, applying steam to the laundry dryer can create various effects besides a drying effect. Accordingly, diverse operating courses may be provided depending on the purposes of using steam.

The refresh course can be expanded to treat the wet object. That is, after the drying process for drying the wet object, a steam course, which is performed identically or similarly to the refresh course, can be performed. Such a course will be referred to as a dry steam course, for convenience of explanation.

The dry steam course includes a drying process, in which the laundry is dried by supplying hot air to the drum before supplying steam to the drum.

For example, the dry steam course may include the drying process, the steam generating process, the steam supplying process, and the drying or cooling process. Here, the last process, i.e., the drying or cooling process may be added as needed.

The total operating time T1 of the dry steam course is the sum of the drying process time T5, the steam generating process time T2 and the steam supplying process time T3.

Also in such a case, it is preferable to display the total operating time at the beginning of the course. Further, it is preferable to sense a temperature of water for steam generation at the end of the drying process. Depending on the sensed temperature, the steam generating process time is determined.

For example, if the steam generating process time is determined to 2 minutes, it can be controlled such that the drying process is performed for a preset time, and the total operating time T1 is corrected based on the determined steam generating process time T2. In such a case, the corrected total operating time is displayed. That is, the total operating time, which is shortened by 2 minutes, is displayed. On the other hand, if the steam generating process time is determined to 6 minutes, the total operating time, which is extended by 2 minutes, is displayed. At this time, the corrected total operating time means a remaining operating time, which is a total operating time from which the elapsed operating time is deducted.

Also in such a case, it can be controlled such that the preset total operating time is kept without being corrected. That is, it is possible to keep the preset total operating time T1 by correcting the operating time of the sub-processes, such as the drying process and the steam supplying process.

For example, if the steam generating process time is determined to 2 minutes, the drying process time may be extended by 2 minutes. On the other hand, if the steam generating process time is determined to 6 minutes, the drying process time may be shortened by 2 minutes. As such, it can be controlled such that the time deviation is compensated through the respective sub-processes. Accordingly, the preset total operating time can be kept without being corrected.

The aforementioned dry steam course is configured such that the drying process and the steam generating process are separated with a time interval. However, the steam generating process may be performed during the drying process. In such a case, since a time necessary to separately perform only the steam generating process is not needed, the total operating time can be shortened. However, there may occur a problem such that instant power consumption in the laundry dryer is increased due to the operation of the heater for the drying process and the operation of the heater of the steam generating device for steam generation. In such a case, if the capacity of the heater for the drying process can be varied, it can be controlled such that the drying process is performed with a reduced capacity of the heater. Moreover, it may be possible to achieve an expected purpose of the drying process by making the steam generating process to be performed at the end of the drying process.

For example, if the drying process time is preset to 12 minutes, the drying process is performed with a large heater capacity for 8 minutes, and is performed with a small heater capacity for 4 minutes. For 4 minutes necessary to perform the drying process with a small heater capacity, the steam generating process is also performed.

However, the steam generating process time may be determined to 2 minutes by sensing a temperature of water for steam generation at the beginning of the drying process. In such a case, it can be controlled such that the drying process is performed with a large heater capacity for 10 minutes, and is performed with a small heater capacity for 2 minutes. In the same manner, for 2 minutes necessary to perform the drying process with a small heater capacity, the steam generating process is also performed. As such, since the whole drying process time is not changed, the total operating time can be kept. However, a time necessary to dry the laundry with a large heater capacity in the drying process is varied.

On the other hand, the steam generating process time may be determined to 6 minutes by sensing a temperature of water for steam generation at the beginning of the drying process. In such a case, it can be controlled such that the drying process is performed with a large heater capacity for 6 minutes, and is performed with a small heater capacity for 6 minutes.

The drying process may be configured to supply hot air with a small heater capacity continuously. In such a case, the steam generating process may be performed at the end of the drying process. That is, the drying process time may be preset to 12 minutes. Such a process is for increasing an ambient temperature in the drum to maximize a steam supply effect, rather than for drying the wet object. In addition, such a process is for decreasing damage to the dry clothes due to heat and removing odor or dusts.

In the same manner, if the steam generating process time is determined to 2 minutes, the drying process time is corrected to 10 minutes. If the steam generating process time is determined to 6 minutes, the drying process time is corrected to 14 minutes. That is, it can be controlled such that the drying process is continuously performed for the corrected time, and the total operating time is corrected based on the corrected drying process time.

In the above description, the present invention has been explained with reference to the laundry dryer using steam. However, the present invention is not limited to the laundry dryer using steam, but can also be applied to a washing machine or a dishwasher using steam.

The steam home appliance according to the present invention can enhance user's convenience by displaying a correct operating time to a user.

Further, the steam home appliance according to the present invention can prevent a user from misunderstanding that the steam home appliance is erroneously operated due to deviation of an operating time, by providing a user with information about a correct operating time.

Further, the steam home appliance according to the present invention enables a user to efficiently do other household affairs during the use of the steam home appliance, by providing a user with information about a correct operating time. Accordingly, since a user can effectively use the steam home appliance and also can efficiently use time without an unnecessary waste, user's life quality can be improved.

Further, the laundry dryer according to the present invention does not only dry the object, but also can remove wrinkles, static and odor from the object, thereby maximizing a degree of practical use of the laundry dryer.

Still further, in spite of deviation of a time necessary to generate steam, a whole operating algorithm or detailed algorithms of an optimum course, which has been programmed in advance, is not remarkably changed. Accordingly, the steam home appliance according to the present invention can be effectively operated.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for controlling a steam home appliance, the method comprising:
sensing a temperature of water for generating steam;
determining a heating time of heating water to generate steam according to the sensed temperature; and
correcting a predetermined operating time of the steam home appliance according to the determined heating time.

2. The method according to claim 1, wherein the heating time is a time from starting heating water to starting supplying steam to an object storing part.

3. The method according to claim 1, further comprising:
displaying the predetermined operating time when operation is started.

4. The method according to claim 3, wherein the step of displaying includes displaying a remaining operating time as time passes by.

5. The method according to claim 4, wherein the step of displaying includes displaying the remaining operating time depending on the corrected operating time.

6. The method according to claim 1, wherein the predetermined operating time is predetermined according to an operating course or the amount of object at the beginning of operation.

7. The method according to claim 1, wherein the steam home appliance includes an operating course having a steam generating process of heating water to generate steam, and a steam supplying process of supplying the generated steam to an object storing part.

8. The method according to claim 7, wherein the step of determining includes determining a time necessary for the steam generating process.

9. The method according to claim 8, wherein the step of correcting includes correcting the predetermined operating time according to the determined time necessary for the steam generating process.

10. The method according to claim 7, wherein the operating course further includes a cooling process of lowering a temperature in the object storing part after the steam supplying process.

11. The method according to claim 7, wherein the operating course further includes a drying process of supplying hot air to the object storing part before the steam supplying process.

12. A method for controlling a steam home appliance, the method comprising:
sensing a temperature of water for generating steam;
determining a heating time of heating water to generate steam according to the sensed temperature; and
correcting a time necessary for a sub-process to keep a predetermined operating time of the steam home appliance according to the determined heating time.

13. The method according to claim 12, wherein the steam home appliance includes an operating course having a steam generating process of heating water to generate steam, and a steam supplying process of supplying the generated steam to an object storing part.

14. The method according to claim 12, wherein the sub-process, the time necessary for which is corrected, includes other processes except for the steam generating process.

15. The method according to claim 14, wherein the operating course further includes the sub-process including at least one of a drying process of supplying hot air to the object storing part before the steam supplying process and a cooling process of lowering a temperature in the object storing part after the steam supplying process.

16. The method according to claim 15, wherein the sub-process, the time necessary for which is corrected, is the drying process.

17. The method according to claim 16, further comprising:
displaying the predetermined operating time when operation is started.

18. The method according to claim 17, wherein the step of displaying includes displaying a remaining operating time as time passes by.

19. The method according to claim 18, wherein the step of displaying includes displaying the remaining operating time depending on the corrected time necessary for the sub-process.

20. The method according to claim 12, wherein the predetermined operating time is predetermined according to an operating course or the amount of object at the beginning of operation.
